(19) United States
(12) Patent Application Publication
(10) Pub. No.: US 2018/0371308 A1
(43) Pub. Date: Dec. 27, 2018

(54) FOOD GRADE MATERIAL AS EFFECTIVE CLAY CONTROL AGENT

(71) Applicant: Halliburton Energy Services, Inc., Houston, TX (US)

(72) Inventors: Sairam ELURU, Pune (IN); Monalisa MALLICK, Kolkata (IN); Rajender SALLA, Pune (IN)

(21) Appl. No.: 15/777,106

(22) PCT Filed: Feb. 4, 2016
(86) PCT No.: PCT/US16/16559

§ 371 Date: May 17, 2018

(51) Int. Cl. C09K 8/60; C09K 8/04; C09K 8/86; C09K 8/68; E21B 21/00; E21B 43/267

(52) U.S. Cl. CPC C09K 8/607; C09K 8/04; C09K 8/86; C09K 2208/12; E21B 21/00; E21B 43/267; C09K 8/68

(57) ABSTRACT

A well treatment fluid comprising an aqueous base fluid and a clay control agent is provided. The clay control agent is fast green. In one form, the fast green has the formula C₃₇H₃₇N₂O₁₀S₃+. Clay control agents in addition to fast green can also be included. Also provided is a method of treating a subterranean formation in order to stabilize water-sensitive clay minerals in the formation.

### BACKGROUND

The recovery of hydrocarbons from subterranean formations that contain clay minerals that are sensitive to water (“water-sensitive clay minerals) can be difficult. Water-sensitive clay minerals are clay minerals that tend to swell and/or migrate when contacted by aqueous well treatment fluids.

For example, clay swelling due to clay minerals present in an aqueous based drilling fluid can significantly increase the bulk volume of the drilling fluid and thereby adversely impact the overall drilling operation. For example, removal of cuttings can be impeded, friction between the drill string and the sides of the borehole can be increased, filter cake formation can be inhibited and circulation can be lost.

Clay swelling can also be a problem in carrying out fracturing operations. For example, clay swelling and migration in the formation due to pumping an aqueous fracturing fluid into the formation can block passageways to the wellbore, thereby causing a loss in the permeability of the formation. A loss in the permeability of the formation can impair the flow of fluid through the wellbore and, in some cases completely block the flow of fluid through portions of the formation. This can lead to a decrease in the rate of recovery of hydrocarbons from the well. Moreover, migrating clays can be produced with the formation fluids which can result in abrasion and other problems with production and other equipment.

The problems associated with clay minerals in the formation can be addressed by pre-flushing the formation with one or more slugs of salt-containing water and/or including inorganic salts in aqueous well treatment fluids. For example, adding potassium chloride (KCl) to the flush water and/or well treatment fluids can convert the clay minerals to less swellable forms by cation exchange with ions present on the clay mineral surfaces. Other salts that have been used for this purpose include calcium chloride and ammonium chloride.

Unfortunately, the use of salts to inhibit clay swelling in the formation can be problematic in some circumstances. For example, it can be difficult to dissolve the amount of salt needed to inhibit clay swelling in the well treatment fluid. Also, in environmentally sensitive areas, there may be limits on the permissible amount of salt that can be added to the formation. In addition, the presence of salts in the well treatment fluid or formation may interact with other components of the well treatment fluid. For example, the presence of salt can make it difficult to hydrate viscosifying agents in the well treatment fluid.

### BRIEF DESCRIPTION OF THE DRAWINGS

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

FIG. 1 is a diagram illustrating an example of a drilling system that can be used in accordance with certain embodiments of the present disclosure.

FIG. 2 is a diagram illustrating an example of a fracturing system that can be used in accordance with certain embodiments of the present disclosure.

FIG. 3 is a diagram illustrating an example of a subterranean formation in which a fracturing operation can be performed in accordance with certain embodiments of the present disclosure.

### DETAILED DESCRIPTION

The present disclosure may be understood more readily by reference to this detailed description as well as to the examples included herein. For simplicity and clarity of illustration, where appropriate, reference numerals may be repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts have been exaggerated to better illustrate details and features of the present disclosure.

In accordance with the present disclosure, a well treatment fluid and a method of treating a subterranean formation in order to stabilize water-sensitive clay minerals in the formation are provided. As used herein and in the appended claims, clay minerals, water-sensitive clay minerals, clay and water-sensitive clay are used interchangeably to mean clay minerals that tend to swell and/or migrate when contacted by water. For example, clay swelling occurs when water molecules surround a clay crystal structure and position themselves so as to increase spacing within the structure thus resulting in an increase in volume. Clay swelling can occur due to surface hydration and/or osmotic swelling. Examples of clays that tend to swell when contacted with water include clays in the smectite group, kaolin clays, illite clays, and chlorite clays.

As used herein and in the appended claims, a well treatment fluid means any fluid introduced into the well in connection with drilling, completing, working over and/or stimulating production from the well, including aqueous injection fluids, drilling muds and other drilling fluids, pre-flush treatment fluids, completion fluids, work-over fluids, fracturing fluids and other stimulation fluids.

The well treatment fluid disclosed herein comprises an aqueous base fluid and a clay control agent.

For example, the aqueous base fluid can be water. The water can be fresh water, sea water, brine, produced water, and mixtures thereof.

The clay control agent of the well treatment fluid is fast green. Fast green has the formula C₃₇H₃₇N₂O₁₀S₃+. As a salt, for example, fast green has the formula C₃₇H₃₄N₂O₁₀S₃Na₂.

For example, the chemical name of fast green is ethyl-[4-[[4-[ethyl-[(3-sulfophenyl) methyl]amino]phenyl]-(4-hydroxy-2-sulfophenyl) methylidene]-1-cyclohexa-2,5-dienylidene]-[(3-sulfophenyl) methyl]azanium. Fast green is known for use as a food dye, biological stain, paint and general stain. It is highly soluble in water and an electroactive compound. It has good thermal stability.

Fast green is also referred to as Fast Green FCF, FD&C Green No. 3, Green 1724, Solid Green FCF, and C.I. 42053. The E Number of the compound is E143. The CAS Number of the compound is 2353-45-9. The molar mass of the compound is 765.89 g/mol.

For example, the clay control agent of the well treatment fluid can have the structural formula (1) below:

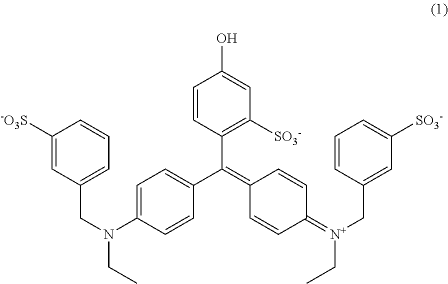

For example, the clay control agent of the well treatment fluid disclosed herein converts the clay minerals to less swellable forms by cation exchange with ions present on the clay mineral surfaces.

The clay control agent is used in the well treatment fluid in an amount sufficient to inhibit swelling of clay in the well treatment fluid and/or formation depending on the application. The exact amount of the clay control agent that should be used in a given application can be determined, for example, by a trial and error method of testing a sample of the particular well treatment fluid to be used with respect to a sample of the formation. Generally, however, the clay control agent can be present in the base treatment fluid of the well treatment fluid in an amount in the range of from about 0.001% to about 15% by weight, based on the total weight of the treatment fluid. For example, the clay control agent can be present in the base treatment fluid of the well treatment fluid in an amount in the range of from about 0.01% to about 5% by weight, based on the total weight of the treatment fluid. For example, the clay control agent can be present in the base treatment fluid of the well treatment fluid in an amount in the range of from about 0.05% to about 1.0% by weight, based on the total weight of the treatment fluid.

For example, the clay control agent can be blended with the aqueous base fluid of the well treatment fluid at the site of the well. For example, the clay control agent can be added to the aqueous base fluid on the fly as the well treatment fluid is pumped into the wellbore.

One or more clay control agents in addition to fast green may also be included in the well treatment fluid disclosed herein. For example, the well treatment fluid can also include one or more salts as the treatment permits. For example, the well treatment fluid can also include a clay damage control additive (for example, for use in low permeability formations) sold by Halliburton Energy Services, Inc. in association with the trade name CLA-WEB®. For example, the well treatment fluid can also include a clay control additive sold by Halliburton Energy Services, Inc. in association with the trade name CLAYFIX II+™.

Additional components can also be included in the well treatment fluid disclosed herein. The additional components included in the well treatment fluid will depend on the intended use of the well treatment fluid.

For example, the well treatment fluid can be used as an aqueous-based drilling fluid for use in drilling wells through shale that contains clay minerals which swell in the presence of water. In addition to water and the clay control agent, the drilling fluid can contain, for example, one or more weighting materials, fluid loss control additives, bridging materials, lubricants, corrosion inhibition agents, and/or suspending agents. For example, clay cuttings that become dispersed in the drilling fluid due to the action of the drill bit or other clay that gets into the drilling fluid are controlled by the clay control agent.

For example, the well treatment fluid can be a pre-flush fluid introduced into the formation prior to a fracturing treatment in order to stabilize water-sensitive clay in the formation with respect to clay swelling.

The well treatment fluid can also be an aqueous based fracturing fluid that is pumped through the wellbore and into the formation at a sufficient pressure to fracture or extend an existing fracture in the formation. In addition to water and the clay control agent, the fracturing fluid can include a plurality of proppant particulates (for example, in the proppant slurry stages of the treatment) for propping open the fractures, gels, cross-linkers and other viscosifying agents, breakers and stabilizers. The fracturing fluid can maintain existing clay stabilization in the formation and inhibit swelling of newly exposed clay during the treatment.

The clay control agent of the well treatment fluid of the present disclosure effectively inhibits clay swelling and migration caused by the use of aqueous fluids in water-sensitive formations while being generally inert with respect to typical components of well treatment fluids and not imparting potentially problematic salt and chloride ions to the formation. For example, the clay control agent can also act as an efficient corrosion inhibitor and chelating agent in the well treatment fluid. It is environmentally friendly.

An added benefit of the clay control agent of the well treatment fluid disclosed herein is that because fast green is a colorant, it can be used to provide information regarding various characteristics of the formation including the bed formation and flow path direction in the formation. For example, flow characteristics (such as flow path direction) of at least a portion of the formation can be analyzed based on the color of the clay control agent and the resulting color of the well treatment fluid. For example, the colorant functionality of fast green allows accurate information to be visually provided regarding the bed formation and flow path direction in capillary suction time tests carried out on the well treatment fluid and a portion of the formation.

The method of treating a subterranean formation in order to stabilize water-sensitive clay minerals in the formation disclosed herein comprises contacting the formation with the well treatment fluid disclosed herein. The formation is contacted with the well treatment fluid by introducing the well treatment fluid into the formation through the wellbore. For example, the well treatment fluid can be a pre-flush fluid that is pumped into the formation prior to a treatment such as a fracturing treatment. For example, the well treatment fluid can also be the fracturing fluid.

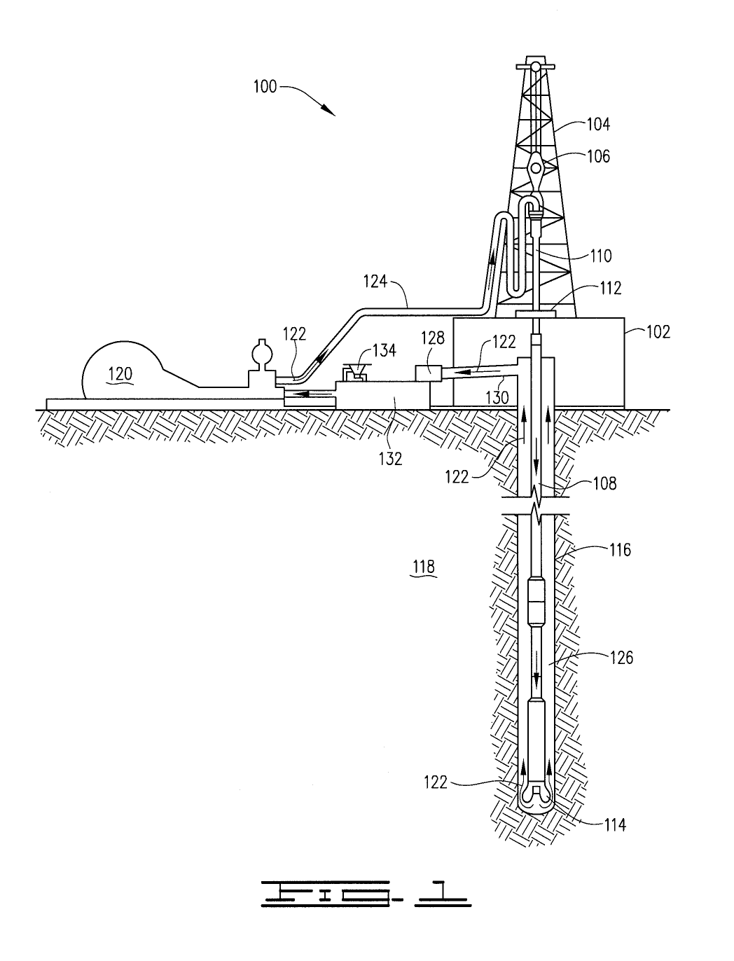

The exemplary chemicals, fluids and additives disclosed herein may directly or indirectly affect one or more components or pieces of equipment associated with the preparation, delivery, recapture, recycling, reuse, and/or disposal of the disclosed chemicals, fluids and additives. For example, referring to FIG. 1, the disclosed chemicals, fluids and additives may directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the disclosure.

One or more of the disclosed chemicals, fluids and additives may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed chemicals, fluids and additives may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed chemicals, fluids and additives may be stored, reconditioned, and/or regulated until added to the drilling fluid 122.

As mentioned above, the disclosed chemicals, fluids and additives may directly or indirectly affect the components and equipment of the drilling assembly 100. For example, the disclosed chemicals, fluids and additives may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, and any fluid reclamation equipment. The fluid processing unit(s) 128 may further include one or more sensors, gauges, pumps, compressors, and the like that are used, for example, to store, monitor, regulate, and/or recondition the exemplary chemicals, fluids and additives.

The disclosed chemicals, fluids and additives may directly or indirectly affect the pump 120, which representatively includes any conduits, pipelines, trucks, tubulars, and/or pipes used to fluidically convey the chemicals, fluids and additives downhole, any pumps, compressors, or motors (e.g., topside or downhole) used to drive the chemicals, fluids and additives into motion, any valves or related joints used to regulate the pressure or flow rate of the chemicals, fluids and additives, and any sensors (i.e., pressure, temperature, flow rate, etc.), gauges, and/or combinations thereof, and the like. The disclosed chemicals, fluids and additives may also directly or indirectly affect the mixing hopper 134 and the retention pit 132 and their assorted variations.

The disclosed chemicals, fluids and additives may also directly or indirectly affect the various downhole equipment and tools that may come into contact with the chemicals, fluids and additives such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed chemicals, fluids and additives may also directly or indirectly affect any downhole heat exchangers, valves and corresponding actuation devices, tool seals, packers and other wellbore isolation devices or components, and the like associated with the wellbore 116. The disclosed chemicals, fluids and additives may also directly or indirectly affect the drill bit 114, which may include, but is not limited to, roller cone bits, PDC bits, natural diamond bits, any hole openers, reamers, coring bits, etc.

While not specifically illustrated herein, the disclosed chemicals, fluids and additives may also directly or indirectly affect any transport or delivery equipment used to convey the chemicals, fluids and additives to the drilling assembly 100 such as, for example, any transport vessels, conduits, pipelines, trucks, tubulars, and/or pipes used to fluidically move the chemicals, fluids and additives from one location to another, any pumps, compressors, or motors used to drive the chemicals, fluids and additives into motion, any valves or related joints used to regulate the pressure or flow rate of the chemicals, fluids and additives, and any sensors (i.e., pressure and temperature), gauges, and/or combinations thereof, and the like.

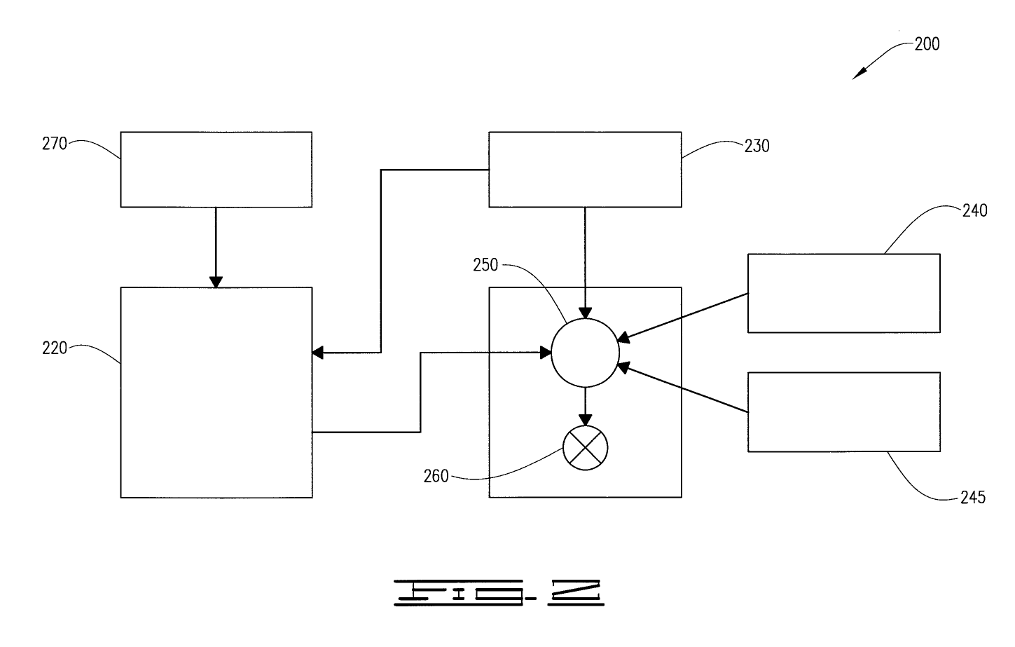

For example, and with reference to FIG. 2, the disclosed methods and compositions may directly or indirectly affect one or more components or pieces of equipment associated with an exemplary fracturing system 200, according to one or more embodiments. In certain instances, the system 200 includes a fracturing fluid producing apparatus 220, a fluid source 230, a proppant source 240, and a pump and blender system 250 and resides at the surface at a well site where a well 260 is located. In certain instances, the fracturing fluid producing apparatus 220 combines a gel precursor with fluid (e.g., liquid or substantially liquid) from fluid source 230, to produce a hydrated fracturing fluid that is used to fracture the formation. The hydrated fracturing fluid can be a fluid for ready use in a fracture stimulation treatment of the well 260 or a concentrate to which additional fluid is added prior to use in a fracture stimulation of the well 260. In other instances, the fracturing fluid producing apparatus 200 can be omitted and the fracturing fluid sourced directly from the fluid source 230. In certain instances, the fracturing fluid may comprise water, a hydrocarbon fluid, a polymer gel, foam, air, wet gases and/or other fluids.

The proppant source 240 can include a proppant for combination with the fracturing fluid. The system may also include an additive source 270 that provides one or more additives (e.g., gelling agents, weighting agents, and/or other optional additives) to alter the properties of the fracturing fluid. For example, additives from the additive source 270 can be included to reduce pumping friction, to reduce or eliminate the fluid's reaction to the geological formation in which the well is formed, to operate as surfactants, and/or to serve other functions.

The pump and blender system 250 receives the fracturing fluid and combines it with other components, including proppant from the proppant source 240 and/or additional fluid from the additive source 270. The resulting mixture may be pumped down the well 260 under a pressure sufficient to create or enhance one or more fractures in a subterranean zone, for example, to stimulate production of fluids from the zone. Notably, in certain instances, the fracturing fluid producing apparatus 200, fluid source 230, and/or proppant source 240 may be equipped with one or more metering devices (not shown) to control the flow of fluids, proppants, and/or other compositions to the pump and blender system 250. Such metering devices may permit the pump and blender system 250 to source from one, some or all of the different sources at a given time, and may facilitate the preparation of fracturing fluids in accordance with the present disclosure using continuous mixing or “on-the-fly” methods. Thus, for example, the pump and blender system 250 can provide just fracturing fluid into the well at some times, just proppants at other times, and combinations of those components at yet other times.

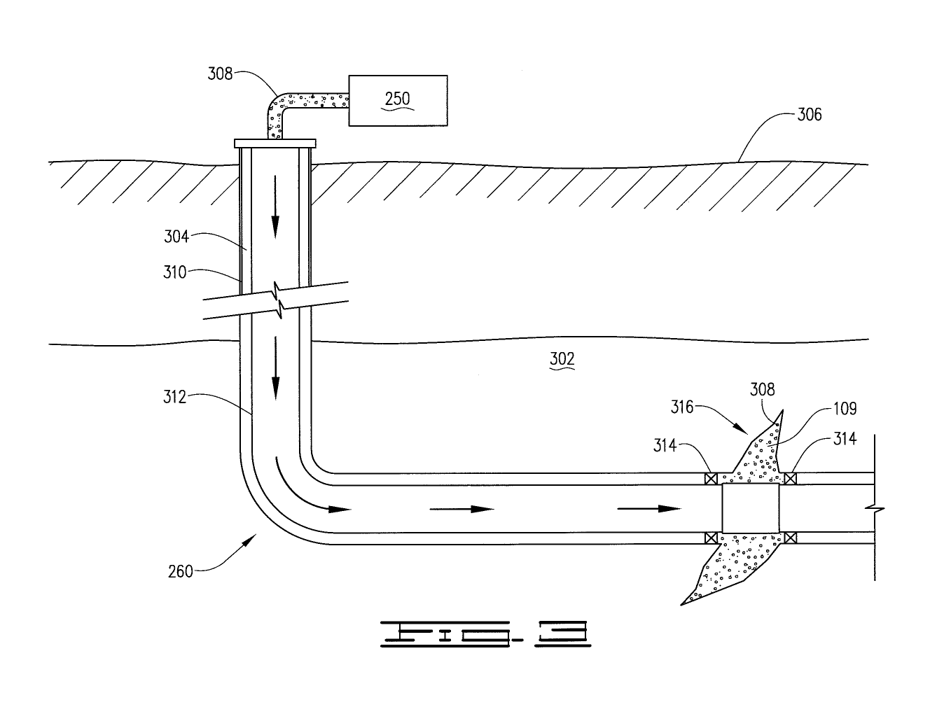

FIG. 3 shows the well 260 during a fracturing operation in a portion of a subterranean formation of interest 302 surrounding a wellbore 304. The wellbore 304 extends from the surface 306, and the fracturing fluid 308 is applied to a portion of the subterranean formation 302 surrounding the horizontal portion of the wellbore. Although shown as vertical deviating to horizontal, the wellbore 304 may include horizontal, vertical, slant, curved, and other types of wellbore geometries and orientations, and the fracturing treatment may be applied to a subterranean zone surrounding any portion of the wellbore. The wellbore 304 can include a casing 310 that is cemented or otherwise secured to the wellbore wall. The wellbore 304 can be uncased or include uncased sections. Perforations can be formed in the casing 310 to allow fracturing fluids and/or other materials to flow into the subterranean formation 302. In cased wells, perforations can be formed using shape charges, a perforating gun, hydro jetting and/or other tools.

The well is shown with a work string 312 depending from the surface 306 into the wellbore 304. The pump and blender system 250 is coupled a work string 312 to pump the fracturing fluid 308 into the wellbore 304. The work string 312 may include coiled tubing, jointed pipe, and/or other structures that allow fluid to flow into the wellbore 304. The work string 312 can include flow control devices, bypass valves, ports, and or other tools or well devices that control a flow of fluid from the interior of the work string 312 into the subterranean zone 302. For example, the work string 312 may include ports adjacent the wellbore wall to communicate the fracturing fluid 308 directly into the subterranean formation 302, and/or the work string 312 may include ports that are spaced apart from the wellbore wall to communicate the fracturing fluid 308 into an annulus in the wellbore between the work string 312 and the wellbore wall.

The work string 312 and/or the wellbore 304 may include one or more sets of packers 314 that seal the annulus between the work string 312 and wellbore 304 to define an interval of the wellbore 304 into which the fracturing fluid 308 will be pumped. FIG. 2 shows two packers 314, one defining an uphole boundary of the interval and one defining the downhole end of the interval. When the fracturing fluid 308 is introduced into wellbore 304 (e.g., in FIG. 2, the area of the wellbore 304 between packers 314) at a sufficient hydraulic pressure, one or more fractures 316 may be created in the subterranean zone 302. The proppant particulates in the fracturing fluid 308 may enter the fractures 316 where they may remain after the fracturing fluid flows out of the wellbore. These proppant particulates may “prop” fractures 316 such that fluids may flow more freely through the fractures 316.

While not specifically illustrated herein, the disclosed chemicals, fluids and additives may also directly or indirectly affect any transport or delivery equipment used to convey the chemicals, fluids and additives to the fracturing system 200 such as, for example, any transport vessels, conduits, pipelines, trucks, tubulars, and/or pipes used to fluidically move the chemicals, fluids and additives from one location to another, any pumps, compressors, or motors used to drive the chemicals, fluids and additives into motion, any valves or related joints used to regulate the pressure or flow rate of the chemicals, fluids and additives, and any sensors (i.e., pressure and temperature), gauges, and/or combinations thereof, and the like.

### EXAMPLE

The following example illustrates specific embodiments consistent with the present disclosure but does not limit the scope of the disclosure or the appended claims. Concentrations and percentages are by weight unless otherwise indicated.

Capillary suction time tests were carried out on the well treatment fluid disclosed herein in order to confirm the ability of the clay control agent to inhibit swelling and migration of clay minerals when contacted by an aqueous fluid in a subterranean formation. For comparison purposes, the same tests were also carried out on aqueous fluids containing other types of clay control agents.

The tests were carried out as follows:

The capillary suction times of samples with aqueous fluids were measured using a Fann CST instrument model 440. First, 2 g of a pulverized formation sample were placed in 50 ml of test fluid and mixed with a magnetic stirrer for 5 minutes. Next, 5 ml of the sample were injected into a cylinder resting on a standard porous filter paper. Concentric electrodes were located 0.5 cm and 1.0 cm from the edge of the cylinder. Both electrodes were connected to a timer, with fluid contact with the first electrode starting the timer and fluid contact with the second electrode stopping the timer. The time interval measured depended on the amount of free water in the pulverized formation sample/treatment fluid slurry and the permeability of the formation mineral filter cake that was deposited. The measurement was normally repeated three times for each sample.

The results of the tests are presented showing the CST times for each fluid and sample tested. In general, the minimum CST indicates maximum swelling/dispersion inhibition. CST is intended as a rapid semi-quantitative method for comparison of a fluid for a specific formation.

The CST ratios were calculated using two different methodologies which are given below.

$$CST Ratio A = \frac{{CST}_{Sample} - {CST}_{Blank}}{{CST}_{Blank}}$$

$$CST Ratio B = \frac{{CST}_{Sample}}{{CST}_{DI}}$$

$${CST}_{sample} = Capillary suction time with the test fl uid using pulverized formation sample$$

$${CST}_{DI} = Capillary suction time with DI Water with pulverized formation sample \\ {CST}_{Blank} = Capillary suction time with DI Water without pulverized formation sample$$

The results of the tests are shown by Table 1 below:

TABLE 1
Capillary Suction Time Values on
Fixed Rock Sample Composition

| Test Recipe | Capillary suction Time |
|---|---|
| Formation water | 61.0 |
| 3% KCl | 24.1 |
| 7% KCl | 18.1 |
| 0.01% CLA-WEB ®* | 30.5 |
| 0.1% CLA-WEB ®* | 17.6 |
| 2% CLAYFIX II+ ™** | 24.7 |
| 3% CLAYFIX II+ ™** | 22.2 |
| 5% CLAYFIX II+ ™** | 21.1 |
| 0.2% Fast Green | 27.2 |
| 0.4% Fast Green | 25.0 |
| 0.5% Fast green (in slight acidic pH) | 22.2 |
| 0.4% Fast green + 3% KCl | 23.0 |

*CLA-WEB ® is a clay stabilization additive sold by Halliburton Energy Services, Inc.
**CLAYFIX II+ ™ is a clay stabilization additive sold by Halliburton Energy Services, Inc.

As shown by Table 1, Fast Green is as effective as a clay control agent as the other known clay control agents tested, and is also compatible with potassium chloride. Fast green is also effective in acidic conditions. Also, the fast green provided accurate information regarding the bed formation and flow path direction in the capillary suction time tests in which it was used.

Therefore, the present compositions and methods are well adapted to attain the ends and advantages mentioned, as well as those that are inherent therein. The particular example disclosed above is illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A well treatment fluid, comprising:
an aqueous base fluid; and
a clay control agent consisting of fast green.

2. The well treatment fluid of claim 1, wherein said clay control agent has the formula C₃₇H₃₇N₂O₁₀S₃+.

3. The well treatment fluid of claim 2, wherein said clay control agent has the following structural formula:

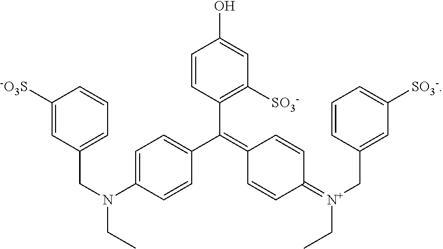

4. The well treatment fluid of claim 1, wherein said clay control agent is present in said well treatment fluid in an amount in the range of from about 0.001% to about 15% by weight, based on the total weight of said treatment fluid.

5. The well treatment fluid of claim 4, wherein said clay control agent is present in said well treatment fluid in an amount in the range of from about 0.01% to about 5% by weight, based on the total weight of said treatment fluid.

6. The well treatment fluid of claim 5, wherein said clay control agent is present in said well treatment fluid in an amount in the range of from about 0.05% to about 1.0% by weight, based on the total weight of said treatment fluid.

7. The well treatment fluid of claim 1, further comprising one or more clay control agents in addition to fast green.

8. A well treatment fluid, comprising:
an aqueous base fluid; and
a clay control agent, said clay control agent having the formula C₃₇H₃₇N₂O₁₀S₃+ said being present in said well treatment fluid in an amount in the range of from about 0.001% to about 15% by weight, based on the total weight of said treatment fluid.

9. The well treatment fluid of claim 8, wherein said clay control agent is present in said well treatment fluid in an amount in the range of from about 0.01% to about 5% by weight, based on the total weight of said treatment fluid.

10. The well treatment fluid of claim 8, further comprising one or more additional clay control agents.

11. A method of treating a subterranean formation in order to stabilize water-sensitive clay minerals in the formation, comprising;
contacting the formation with a well treatment fluid, said well treatment fluid including:
an aqueous base fluid; and
a clay control agent consisting of fast green.

12. The method of claim 11, wherein said clay control agent has the formula C₃₇H₃₇N₂O₁₀S₃+.

13. The method of claim 12, wherein said clay control agent has the following structural formula:

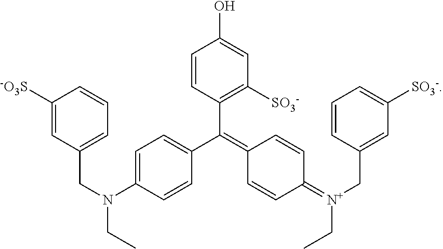

14. The method of claim 11, wherein said clay control agent is present in said well treatment fluid in an amount in the range of from about 0.001% to about 15% by weight, based on the total weight of said treatment fluid.

15. The method of claim 14, wherein said clay control agent is present in said well treatment fluid in an amount in the range of from about 0.01% to about 5% by weight, based on the total weight of said treatment fluid.

16. The method of claim 15, wherein said clay control agent is present in said well treatment fluid in an amount in the range of from about 0.05% to about 1.0% by weight, based on the total weight of said treatment fluid.

17. The method of claim 11, wherein said well treatment fluid includes one or more clay control agents in addition to fast green.

18. The method of claim 11, further comprising analyzing flow characteristics of at least a portion of the formation based on the color of said clay control agent and said well treatment fluid.

19. The method of claim 11 further comprising mixing the well treatment fluid using mixing equipment.

20. The method of claim 11 wherein the well treatment fluid is introduced into a subterranean formation using one or more pumps.
